(19) United States
(12) Patent Application Publication
(10) Pub. No.: US 2025/0114761 A1
(43) Pub. Date: Apr. 10, 2025

(54) CHEMICAL LOOPING SYSTEM, MATERIAL FOR CHEMICAL LOOPING SYSTEM AND PRODUCTION METHOD OF MATERIAL FOR CHEMICAL LOOPING SYSTEM

(71) Applicants: ENEOS Corporation, Chiyoda-ku, Tokyo (JP); WASEDA UNIVERSITY, Shinjuku-ku, Tokyo (JP)

(72) Inventors: Yuichiro HIRANO, Chiyoda-ku, Tokyo (JP); Naoki ITO, Chiyoda-ku, Tokyo (JP); Yasushi SEKINE, Shinjuku-ku, Tokyo (JP); Junichiro MAKIURA, Shinjuku-ku, Tokyo (JP)

(73) Assignees: ENEOS Corporation, Chiyoda-ku, Tokyo (JP); WASEDA UNIVERSITY, Shinjuku-ku, Tokyo (JP)

(21) Appl. No.: 18/729,757

(22) PCT Filed: Dec. 27, 2022
(86) PCT No.: PCT/JP2022/048212

§ 371 Date: Jul. 17, 2024

(30) Foreign Application Priority Data
Jan. 18, 2022 (JP) 2022-005971

(51) Int. Cl. B01J 8/26; B01J 8/18; C01B 32/40; C01G 51/40; C01G 53/40

(52) U.S. Cl. CPC B01J 8/26; B01J 8/1827; C01B 32/40; C01G 51/40; C01G 53/40

(57) ABSTRACT

A chemical looping system includes repeating: a generation process of reacting a reduced form of a material for the chemical looping system, which contains a first element selected from the group consisting of Co and Ni and a second element selected from the group consisting of In and Ga, with carbon dioxide so as to generate an oxidized form of the material for the chemical looping system, in which the second element is oxidized by the reaction, and carbon monoxide, and a reduction treatment of reacting the oxidized form with a reducing agent and thus reducing the second element having been oxidized in the generation process so as to thereby convert the oxidized form back into the reduced form.

### CROSS-REFERENCE TO RELATED APPLICATIONS

This application is based upon and claims the benefit of priority from the prior Japanese Patent Application No. 2022-005971, filed on Jan. 18, 2022, and the International Patent Application No. PCT/JP2022/048212, filed on Dec. 27, 2022, the entire content of each of which is incorporated herein by reference.

### BACKGROUND

### Field of the Invention

The present invention relates to chemical looping systems, materials for the chemical looping systems, and production methods of the materials for the chemical looping systems.

### Description of the Related Art

A technology for producing carbon monoxide by reducing carbon dioxide contained in exhaust gas or the like using a chemical looping system is known (see Patent Literature 1). In a chemical looping system, a reaction in which carbon dioxide is reduced to carbon monoxide using a material for the chemical looping system serving as a mediator and a reaction in which the material for the chemical looping system oxidized in the reaction is reduced with hydrogen are repeated.

Patent Literature 1: WO 2019/163968

Although it is possible to produce carbon monoxide using conventional chemical looping systems, there is always a need to improve the efficiency of carbon monoxide production.

### SUMMARY OF THE INVENTION

The present invention has been made in view of such circumstances, and one of the purposes thereof is to provide a technology for improving the production efficiency of carbon monoxide in a chemical looping system.

An embodiment of the present invention relates to a chemical looping system. This system includes repeating: a generation process of reacting a reduced form of a material for the chemical looping system, which contains a first element selected from the group consisting of Co and Ni and a second element selected from the group consisting of In and Ga, with carbon dioxide so as to generate an oxidized form of the material for the chemical looping system, in which the second element is oxidized by the reaction, and carbon monoxide; and a reduction treatment of reacting the oxidized form with a reducing agent and thus reducing the second element having been oxidized in the generation process so as to thereby convert the oxidized form back into the reduced form.

Another embodiment of the present invention relates to a material for a chemical looping system. This material includes a first element selected from the group consisting of Co and Ni and a second element selected from the group consisting of In and Ga.

Another embodiment of the present invention relates to a production method of the material for the chemical looping system. This production method includes heating a precursor that contains a first element selected from the group consisting of Co and Ni and a second element selected from the group consisting of In and Ga at a temperature equal to or greater than reduction treatment temperature for the material for the chemical looping system in the chemical looping system so as to generate the material for the chemical looping system.

Optional combinations of the aforementioned constituting elements, and implementations of the present disclosure in the form of methods, apparatuses, and systems may also be practiced as additional modes of the present disclosure.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a schematic diagram of a chemical looping system;

FIG. 2 is a flow diagram of a carbon monoxide production method performed in Exemplary Embodiments 1 to 6 and Comparative Examples 1 and 2; and

FIG. 3 is a diagram showing the composition, evaluation temperature, and CO₂ conversion rate of a material for a chemical looping system in each exemplary embodiment and each comparative example.

Hereinafter, the present invention will be described based on preferred embodiments with reference to the drawings. The embodiments do not limit the technical scope of the present invention and are shown for illustrative purposes, and not all the features described in the embodiments and combinations thereof are necessarily essential to the invention. Therefore, regarding the details of the embodiments, many design modifications such as change, addition, deletion, etc., of the constituent elements may be made without departing from the spirit of the invention defined in the claims. New embodiments resulting from added design change will provide the advantages of the embodiments and variations that are combined. In the embodiments, the details for which such design change is possible are emphasized with the notations “according to the embodiment,” “in the embodiment,” etc. However, design change is also allowed for those without such notations. Optional combinations of the constituting elements described in the embodiments are also valid as embodiments of the present invention.

The same or equivalent constituting elements, members, and processes illustrated in each drawing shall be denoted by the same reference numerals, and duplicative explanations will be omitted appropriately. The scales and shapes of parts shown in each figure are set for the sake of convenience in order to facilitate the explanation and shall not be interpreted in a limited manner unless otherwise mentioned. Terms like “first,” “second,” etc., used in the specification and claims do not indicate an order or importance by any means and are used to distinguish a certain feature from the others. Some of the components in each figure may be omitted if they are not important for explanation.

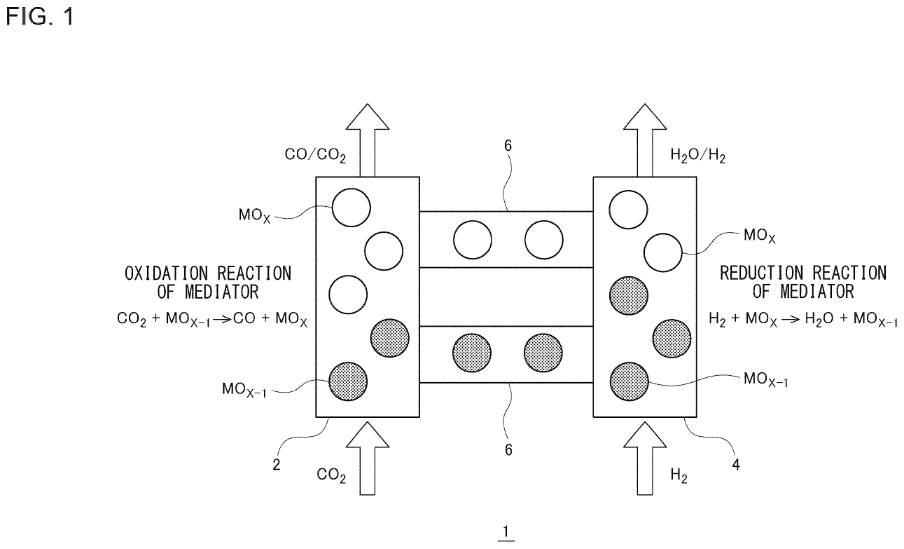

First, an outline of a chemical looping system according to the present embodiment will be explained. FIG. 1 is a schematic diagram of a chemical looping system 1. In the chemical looping system 1, oxidation treatment and reduction treatment of a material for a chemical looping system serving as a mediator are repeated. The material for the chemical looping system changes from a reduced form MO_{x-y} to an oxidized form MOₓ through the oxidation treatment, and from the oxidized form MOₓ to the reduced form MO_{x-y} through the reduction treatment. x and y are numbers greater than 0 and satisfy a relationship x>y.

As an example, the chemical looping system 1 includes an oxidation column 2, a reduction column 4, and a circulation path 6 connecting the oxidation column 2 and the reduction column 4. In the oxidation column 2, there is a reduced form MOₓ₋₁ of a material for a chemical looping system. An explanation will be given using MOₓ₋₁ as an example of a reduced form here. Alternatively, the reduced form may be MO_{x-y} where y represents a number other than 1 such as MOₓ₋₂. Further, there may be a plurality of reduced forms in a mixed manner.

Further, carbon dioxide is supplied to the oxidation column 2 from the outside. As the carbon dioxide supplied to the oxidation column 2, carbon dioxide contained in exhaust gas or the like can be used. This can contribute to the realization of carbon neutrality. The source of carbon dioxide is not particularly limited.

When the inside of the oxidation column 2 is heated to a predetermined oxidation treatment temperature, a reduced form MOₓ₋₁ reacts with carbon dioxide and produces an oxidized form MOₓ and carbon monoxide. The oxidation treatment temperature is, for example, 300° C. to 1000° C. This step corresponds to a carbon monoxide generation process (generation step). The carbon monoxide generated is taken out of the system along with unreacted carbon dioxide and used for arbitrary purposes.

The oxide MOₓ generated in the carbon monoxide generation step is sent to the reduction column 4 via the circulation path 6. Further, a reducing agent such as: hydrogen; hydrocarbons; oxygenated hydrocarbons such as alcohols and carboxylic acids; carbon monoxide; hydrazine; hydrogen sulfide; potassium iodide; hydrogen peroxide; and mixtures thereof is supplied to the reduction column 4 from the outside. In the present embodiment, hydrogen is used as an example of the reducing agent. For the hydrogen supplied to the reduction column 4, for example, hydrogen generated using renewable energy such as solar power or wind power can be used. Thereby, the amount of carbon dioxide emissions associated with the operation of the chemical looping system 1 can be reduced, contributing to the realization of carbon neutrality. The source of hydrogen is not particularly limited.

When the inside of the reduction column 4 is heated to predetermined reduction treatment temperature, an oxidized form MOₓ reacts with hydrogen and generates a reduced form MOₓ₋₁ and water. The reduction treatment temperature is, for example, 300° C. to 1000° C. This step corresponds to a reduction treatment (reduction step) in which the oxidized form MOₓ is converted back into the reduced form MOₓ₋₁. The water generated is taken out of the system along with unreacted hydrogen. A part of the oxidized form MOₓ can be changed to the reduced form MOₓ₋₁ only by heating.

The reduced form MOₓ₋₁ generated in the reduction step is sent to the oxidation column 2 via the circulation path 6. This reduced form MOₓ₋₁ is used in the step of generating carbon monoxide and becomes the oxidized form MOₓ again. Thereafter, the step of generating carbon monoxide and the step of reducing the material for the chemical looping system are repeated, continuously generating carbon monoxide.

The heat required for the chemical looping system 1 can be obtained from clean energy such as solar heat. This can contribute to the realization of a carbon neutral cycle. The source of heat is not particularly limited.

FIG. 1 illustrates a fluidized-bed type chemical looping system 1 in which materials for a chemical looping system move back and forth between the oxidation column 2 and the reduction column 4. However, the structure of the chemical looping system 1 is not particularly limited and may be, for example, a fixed-bed type (switching method) structure. In the case of the fixed-bed type, the supply of carbon dioxide and the supply of the reducing agent are alternately switched for one reactor filled with the material for the chemical looping system, and the step of generating carbon monoxide and the step of reducing the material for the chemical looping system are repeated.

An important element in the chemical looping system 1

is the material for the chemical looping system serving as a mediator. As a result of intensive study regarding materials for a chemical looping system, the present inventors have come up with an idea that carbon monoxide can be efficiently produced by using a compound having a specific composition as a material for a chemical looping system.

The material for the chemical looping system according to the present embodiment includes a first element selected from the group consisting of Co (cobalt) and Ni (nickel) and a second element selected from the group consisting of In (indium) and Ga (gallium). The material for the chemical looping system (e.g., the second element) is oxidized to become an oxidized form of the material for the chemical looping system when the reduced form of the material for the chemical looping system reacts with carbon dioxide. Further, when the oxidized form reacts with a reducing agent, the material for the chemical looping system (e.g., the second element) oxidized by carbon dioxide is reduced and converted back into the reduced form. By combining either one of Co and Ni with either one of In and Ga, the production efficiency of carbon monoxide can be improved.

### Co—In Based Materials

In an example of the material for the chemical looping system, the first element is Co and the second element is In. Hereinafter, this material for the chemical looping system is referred to as a Co—In based material. Co—In based materials are produced by reducing a precursor containing Co and In through reaction with a reducing agent such as hydrogen. This reaction is represented by the following Reaction Formula 1-1. The precursor may differ in composition depending on the combination of the first and second elements. In the case of a Co—In based material, the precursor is composed of a mixture of Co oxide and In oxide.

Co₃O₄/4In₂O₃+13H₂→3CoIn₂/In₂O₃+13H₂O [Reaction Formula 1-1]

In Reaction Formula 1-1, Co₃O₄/4In₂O₃ is a precursor. In Reaction Formula 1-1, Co₃O₄ and In₂O₃ are listed as oxides of the respective elements; however, the composition of the oxides is not limited thereto. Further, 3CoIn₂/In₂O₃ is a reduced form of a Co—In based material. In Reaction Formula 1-1, a Co—In alloy CoIn₂ and an In oxide In₂O₃ are listed as substances contained in the Co—In based material; however, the composition of the Co—In alloy and the composition of the In oxide are not limited thereto. Further, the Co—In based material can also contain a single-component metal of each element (particularly a single-component metal of Co), a composite oxide, a simple oxide of each element, an unreacted precursor, and the like. The presence or absence and ratio of each substance in the Co—In based material can vary depending on reduction conditions.

Preferably, the precursor is heated at a temperature equal to or greater than the reduction treatment temperature for the material for the chemical looping system in the chemical looping system. More preferably, the precursor is heated at a temperature higher than the reduction treatment temperature. That is, the production step of the material for the chemical looping system (Reaction Formula 1-1) is preferably performed as a separate step from the reduction step in the chemical looping system (Reaction Formula 1-3 described later) in terms of processing temperature. Thereby, it is possible to make it easier to produce a reduced form of a Co—In based material. Further, a reduced form having a more suitable composition can be obtained. In the production process of the material for the chemical looping system, the reduction treatment of the precursor may be stopped at Co/2In₂O₃, and then the reduction step in the chemical looping system may be performed to complete a reduction form (CoIn₂/In₂O₃) of the Co—In based material.

In the step of generating carbon monoxide in the chemical looping system, the reduced form of the Co—In based material is oxidized, and carbon dioxide is reduced to produce an oxidized form of the Co—In based material and carbon monoxide. This reaction is represented by the following Reaction Formula 1-2.

CoIn₂/In₂O₃+3CO₂→Co/2In₂O₃+3CO [Reaction Formula 1-2]

As shown in Reaction Formula 1-2, a Co—In alloy takes away oxygen (O²⁻) from carbon dioxide, thereby producing carbon monoxide, which is the target substance. Furthermore, In is more likely to bond with oxygen than with Co. For this reason, In of the Co—In alloy bonds with the oxygen taken away from carbon dioxide to form an In oxide. The composition of the Co—In alloy and the composition of the In oxide are not limited to CoIn₂ and In₂O₃.

In the reduction step of the material for the chemical looping system, the oxide of the Co—In based material is reduced, and the hydrogen serving as a reducing agent is oxidized to produce a reduced form of the Co—In based material and water. This reaction is represented by the following Reaction Formula 1-3.

Co/2In₂O₃+3H₂→CoIn₂/In₂O₃+3H₂O [Reaction Formula 1-3]

As shown in Reaction Formula 1-3, hydrogen takes away oxygen from the In oxide, thereby producing water. Further, In is more stable when bonded with Co than when being in the state of a single-component metal. Therefore, In deprived of oxygen becomes a Co—In alloy. The composition of the Co—In alloy and the composition of the In oxide are not limited to CoIn₂ and In₂O₃. The melting point of In is about 156° C. For this reason, if In is in the state of a single-component metal, liquefaction and subsequent volatilization of In may occur, and the progress of the chemical looping system may be delayed. On the other hand, by alloying In with Co, liquefaction and volatilization of In can be suppressed. Therefore, in a more preferred embodiment, the reduced form of the material for the chemical looping system contains an alloy of the first and second elements.

In the chemical looping system, Reaction Formula 1-2 and Reaction Formula 1-3 are looped. Thereby, the In component in the Co—In based material reversibly changes between the reduced form and the oxidized form. As a result, the Co—In based material reversibly changes between the alloy-rich state (reduced form) and the In oxide-rich state (oxidized form).

### Ni—Ga Based Materials

In another example of the material for the chemical looping system, the first element is Ni and the second element is Ga. Hereinafter, this material for the chemical looping system is referred to as a Ni—Ga based material. Ni—Ga based materials are produced by reducing a precursor containing Ni and Ga through reaction with a reducing agent such as hydrogen. This reaction is represented by the following Reaction Formula 2-1. In the case of Ni—Ga materials, the precursor is composed of a composite oxide of Ni and Ga.

26NiGa₂O₄+70H₂→2Ga₉Ni₁₃/17Ga₂O₂+70H₂O [Reaction Formula 2-1]

In Reaction Formula 2-1, NiGa₂O₄ is a precursor. In Reaction Formula 2-1, NiGa₂O₄ is listed as a composite oxide of the elements; however, the composition of the composite oxide is not limited thereto. Further, 2Ga₉Ni₁₃/17Ga₂O₂ is a reduced form of a Ni—Ga based material. In Reaction Formula 2-1, a Ni—Ga alloy Ga₉Ni₁₃ and a Ga oxide Ga₂O₂ are listed as substances contained in the Ni—Ga based material; however, the composition of the Ni—Ga alloy and the composition of the Ga oxide are not limited thereto. Further, the Ni—Ga based material can also contain a single-component metal of each element (particularly a single-component metal of Ni), a composite oxide, a simple oxide of each element, an unreacted precursor, and the like. The presence or absence and ratio of each substance in the Ni—Ga based material can vary depending on reduction conditions.

As in the case of the Co—In materials, the precursor is preferably heated at a temperature equal to or greater than the reduction treatment temperature for the material for the chemical looping system. That is, the production step of the material for the chemical looping system (Reaction Formula 2-1) is preferably performed as a separate step from the reduction step in the chemical looping system (Reaction Formula 2-3 described later) in terms of processing temperature. Thereby, it is possible to make it easier to produce a reduced form of a Ni—Ga based material. Further, a reduced form having a more suitable composition can be obtained. In the production process of the material for the chemical looping system, the reduction treatment of the precursor may be stopped at Ni/Ga₂O₃, and then the reduction step in the chemical looping system may be performed to complete a reduced form (Ga₉Ni₁₃/Ga₂O₂) of the Ni—Ga based material.

In the step of generating carbon monoxide in the chemical looping system, the reduced form of the Ni—Ga based material is oxidized, and carbon dioxide is reduced to produce an oxidized form of the Ni—Ga based material and carbon monoxide. This reaction is represented by the following Reaction Formula 2-2.

2Ga₉Ni₁₃/17Ga₂O₂+44CO₂→26Ni/26Ga₂O₃₊₄₄CO [Reaction Formula 2-2]

As shown in Reaction Formula 2-2, a Ni—Ga alloy takes away oxygen from carbon dioxide, thereby producing carbon monoxide, which is the target substance. Furthermore, Ga is more likely to bond with oxygen than with Ni. For this reason, Ga of the Ni—Ga alloy bonds with the oxygen taken away from carbon dioxide to form a Ga oxide. The composition of the Ni—Ga alloy and the composition of the Ga oxide are not limited to Ga₉Ni₁₃ and Ga₂O₃.

In the reduction step of the material for the chemical looping system, the oxidized form of the Ni—Ga based material is reduced, and the hydrogen serving as a reducing agent is oxidized to produce a reduced form of the Ni—Ga based material and water. This reaction is represented by the following Reaction Formula 2-3.

26Ni/26Ga₂O₃+44H₂→2Ga₉Ni₁₃/17Ga₂O₂+44H₂O [Reaction Formula 2-3]

As shown in Reaction Formula 2-3, hydrogen takes away oxygen from the Ga oxide, thereby producing water. Further, Ga is more stable when bonded with Ni than when being in the state of a single-component metal. Therefore, Ga deprived of oxygen becomes a Ni—Ga alloy. The composition of the Ni—Ga alloy and the composition of the Ga oxide are not limited to Ga₉Ni₁₃ and Ga₂O₃. The melting point of Ga is about 30° C. For this reason, if Ga is in the state of a single-component metal, liquefaction and subsequent volatilization of Ga may occur, and the progress of the chemical looping system may be delayed. On the other hand, by alloying Ga with Ni, liquefaction and volatilization of Ga can be suppressed. Therefore, in a more preferred embodiment, the reduced form of the material for the chemical looping system contains an alloy of the first and second elements.

In the chemical looping system, Reaction Formula 2-2 and Reaction Formula 2-3 are looped. Thereby, the Ga component in the Ni—Ga based material reversibly changes between the reduced form and the oxidized form. As a result, the Ni—Ga based material reversibly changes between the alloy-rich state (reduced form) and the Ga oxide-rich state (oxidized form).

The material for the chemical looping system may be not only a Co—In based material and a Ni—Ga based material, but also a Co-Ga based material in which the first element is Co and the second element is Ga, or a Ni-In based material in which the first element is Ni and the second element is In.

The embodiments may be defined by the items described in the following.

[Item 1] A chemical looping system including repeating:
a generation process of reacting a reduced form MO_{x-y} of a material for the chemical looping system, which contains a first element selected from the group consisting of Co and Ni and a second element selected from the group consisting of In and Ga, with carbon dioxide so as to generate an oxidized form MOₓ of the material for the chemical looping system, in which the second element is oxidized by the reaction, and carbon monoxide; and
a reduction treatment of reacting the oxidized form MOₓ with a reducing agent and thus reducing the second element having been oxidized in the generation process so as to thereby convert the oxidized form MOₓ back into the reduced form MO_{x-y}.

[Item 2] The chemical looping system according to Item 1, wherein
the reduced form of the material for the chemical looping system contains an alloy of the first and second elements.

[Item 3] The chemical looping system according to Item 1 or 2, wherein
the first element is Co, and the second element is In.

[Item 4] The chemical looping system according to Item 1 or 2, wherein
the first element is Ni, and the second element is Ga.

[Item 5] A material for a chemical looping system, including:
a first element selected from the group consisting of Co and Ni and a second element selected from the group consisting of In and Ga.

[Item 6] A production method of a material for a chemical looping system, including:
heating a precursor that contains a first element selected from the group consisting of Co and Ni and a second element selected from the group consisting of In and Ga at a temperature equal to or greater than reduction treatment temperature for the material for the chemical looping system in the chemical looping system so as to generate the material for the chemical looping system.

[Item 7] A production method of carbon monoxide, including repeating:
a generation step of reacting a reduced form MO_{x-y} of a material for the chemical looping system, which contains a first element selected from the group consisting of Co and Ni and a second element selected from the group consisting of In and Ga, with carbon dioxide so as to generate an oxidized form MOₓ of the material for the chemical looping system, in which the second element is oxidized by the reaction, and carbon monoxide; and
a reduction step of reacting the oxidized form MOₓ with a reducing agent and thus reducing the second element having been oxidized in the generation step so as to thereby convert the oxidized form MOₓ back into the reduced form MO_{x-y}.

### Exemplary Embodiments

Hereinafter, exemplary embodiments of the present invention will be explained. However, the exemplary embodiments are merely examples for suitably explaining the present invention and do not limit the present invention in any way.

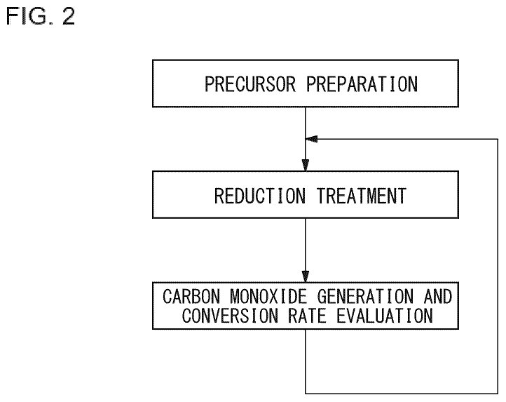

FIG. 2 is a flow diagram of a carbon monoxide production method performed in Exemplary Embodiments 1 to 6 and Comparative Examples 1 and 2. First, precursors according to the exemplary embodiments and the comparative examples were prepared.

More specifically, in Exemplary Embodiments 1 to 3, 2.44 g of Co nitrate hexahydrate (manufactured by Kanto Chemical), 5.95 g of In nitrate trihydrate (manufactured by Kanto Chemical), 15.85 g of citric acid monohydrate (manufactured by Kanto Chemical), and 4.68 g of ethylene glycol (manufactured by Kanto Chemical) were dissolved in 300 mL of pure water, and heat treatment was performed at 80° C. for 17 hours in a water bath. After the heat treatment, the resultant product was heated to about 300° C. on a hot stirrer to remove organic matter. Thereafter, in a firing furnace, the temperature was raised from room temperature to 400° C. at a heating rate of 5° C./min in air, and the temperature was maintained for 2 hours. The temperature was continuously raised to 850° C. at a heating rate of 10° C./min and maintained for 10 hours, and the precursor Co₃O₄/4In₂O₃ according to Exemplary Embodiments 1 to 3 was obtained.

In Exemplary Embodiments 4 to 6, 3.33 g of Ni nitrate hexahydrate (manufactured by Kanto Chemical), 8.33 g of Ga nitrate hexahydrate (manufactured by FUJIFILM Wako Pure Chemical), 21.64 g of citric acid monohydrate (manufactured by Kanto Chemical), and 6.39 g of ethylene glycol (manufactured by Kanto Chemical) were dissolved in 300 mL of pure water, and heat treatment was performed at 80° C. for 17 hours in a water bath. After the heat treatment, the resultant product was heated to about 300° C. on a hot stirrer to remove organic matter. Thereafter, in a firing furnace, the temperature was raised from room temperature to 400° C. at a heating rate of 5° C./min in air, and the temperature was maintained for 2 hours. Then, the temperature was raised to 850° C. at a heating rate of 10° C./min and maintained for 10 hours, and the precursor NiGa₂O₄ according to Exemplary Embodiments 4 to 6 was obtained.

In Comparative Examples 1 and 2, 3.32 g of Cu nitrate Cu(NO₃)₂·3H₂O (manufactured by Kanto Chemical), 4.88 g of In nitrate In(NO₃)₂·nH₂O (manufactured by Kanto Chemical), 17.32 g of citric acid monohydrate (manufactured by Kanto Chemical), and 5.17 g of ethylene glycol (manufactured by Kanto Chemical) were dissolved in 300 mL of pure water, and heat treatment was performed at 80° C. for 17 hours in a water bath. After the heat treatment, the resultant product was heated to about 300° C. on a hot stirrer to remove organic matter. Thereafter, in a firing furnace, the temperature was raised from room temperature to 400° C. at a heating rate of 5° C./min in air, and the temperature was maintained for 2 hours. Then, the temperature was raised to 850° C. at a heating rate of 10° C./min and maintained for 10 hours, and the precursor Cu₂In₂O₅ according to Comparative Examples 1 and 2 was obtained.

Subsequently, each of the obtained precursors was loaded into a reaction tube of a thermogravimetric analyzer (TGA-50, manufactured by Shimadzu Corporation). Then, each precursor was subjected to a reduction treatment so as to obtain a material for the chemical looping system according to each exemplary embodiment and each comparative example. More specifically, in Exemplary Embodiments 1 to 3 and Comparative Examples 1 and 2, 10% H₂/Ar gas by volume was circulated at a flow rate of 100 Ncc/min under atmospheric pressure. In Exemplary Embodiments 4 to 6, 40% H₂/Ar gas by volume was circulated at a flow rate of 100 Ncc/min. Then, the temperature was raised to a predetermined temperature, and the reduction treatment was performed for 30 minutes at the predetermined temperature. The reduction treatment temperature was 400° C. in Exemplary Embodiment 1 and Comparative Example 1, 500° C. in Exemplary Embodiment 2, 600° C. in Exemplary Embodiments 3, 4 and Comparative Example 2, 650° C. in Exemplary Embodiment 5, and 700° C. in Exemplary Embodiment 6.

As a result of this, the reaction represented by Reaction Formula 1-1 occurred in Exemplary Embodiments 1 to 3, the reaction represented by Reaction Formula 2-1 occurred in Exemplary Embodiments 4 to 6, and the reaction represented by the following Reaction Formula 3-1 occurred in Comparative Examples 1 and 2, producing reduced forms of the materials for the chemical looping system in the exemplary embodiments and the comparative examples. The materials were Co—In based materials in Exemplary Embodiments 1 to 3, Ni—Ga based materials in Exemplary Embodiments 4 to 6, and Cu-In based materials in Comparative Examples 1 and 2.

Cu₂In₂O₅+4H₂→2Cu/In₂O+4H₂O [Reaction Formula 3-1]

Subsequently, a carbon monoxide production step was performed. More specifically, while keeping the reaction tube of the thermogravimetric analyzer filled with the material for the chemical looping system at the same temperature as the reduction treatment temperature, a mixed gas whose volume ratio of carbon dioxide to carbon monoxide was a predetermined first ratio was circulated at a flow rate of 100 Ncc/min for the purpose of evaluating the CO₂ conversion rate. When the reduced forms of the materials for the chemical looping system are oxidized by carbon dioxide, the reaction represented by Reaction Formula 1-2 occurs in Exemplary Embodiments 1 to 3, the reaction represented by Reaction Formula 2-2 occurs in Exemplary Embodiments 4 to 6, and the reaction represented by the following Reaction Formula 3-2 occurs in Comparative Examples 1 and 2, producing carbon monoxide.

In₂O+2CO₂→In₂O₃+2CO [Reaction Formula 3-2]

During the carbon monoxide production step, the weight change of each material for the chemical looping system was measured using a thermobalance. Then, based on the weight change, the CO/CO₂ ratio at which the conversion of carbon dioxide to carbon monoxide and the conversion of carbon monoxide to carbon dioxide are in equilibrium, which is called CO₂ conversion rate, was evaluated.

An increase in the weight of a material for the chemical looping system means that the oxidation of the material for the chemical looping system by carbon dioxide predominates, and the conversion of carbon dioxide into carbon monoxide is therefore progressing. On the other hand, a decrease in the weight of a material for the chemical looping system means that the reduction of the material for the chemical looping system by carbon monoxide predominates, and the conversion of carbon monoxide into carbon dioxide is therefore progressing. Therefore, it can be determined that the CO₂ conversion rate of each material for the chemical looping system is between the CO/CO₂ ratio at the time of the weight increase and the CO/CO₂ ratio at the time of the weight decrease. A higher CO₂ conversion rate means that the material for the chemical looping system can produce carbon monoxide from a lower concentration of carbon dioxide at the same processing temperature, that is, the material for the chemical looping system can convert carbon dioxide into carbon monoxide even at a low concentration. Therefore, the higher the CO₂ conversion rate, the higher the carbon monoxide production efficiency.

Going back to the reduction treatment after the carbon monoxide generation step, the material for the chemical looping system was subjected to the reduction treatment under the same conditions as those for the reduction treatment of the precursor. In the reduction treatment, the reaction represented by Reaction Formula 1-3 occurs in the case of a Co—In based material, the reaction represented by Reaction Formula 2-3 occurs in the case of a Ni—Ga based material, and the reaction represented by the following Reaction Formula 3-3 occurs in the case of a Cu—In based material, reducing the oxidized form of each material for the chemical looping system.

In₂O₃+2H₂→In₂O+2H₂O [Reaction Formula 3-3]

Subsequently, the carbon monoxide generation step and the evaluation of the CO₂ conversion rate were performed. The carbon monoxide generation step was carried out under the same conditions as those for the generation step carried out in one cycle before, except that a mixed gas whose volume ratio of carbon dioxide to carbon monoxide was a second ratio different from the first ratio was circulated. Thereafter, while changing the ratio of carbon dioxide to carbon monoxide, the cycle of reduction treatment to carbon monoxide generation step was repeated.

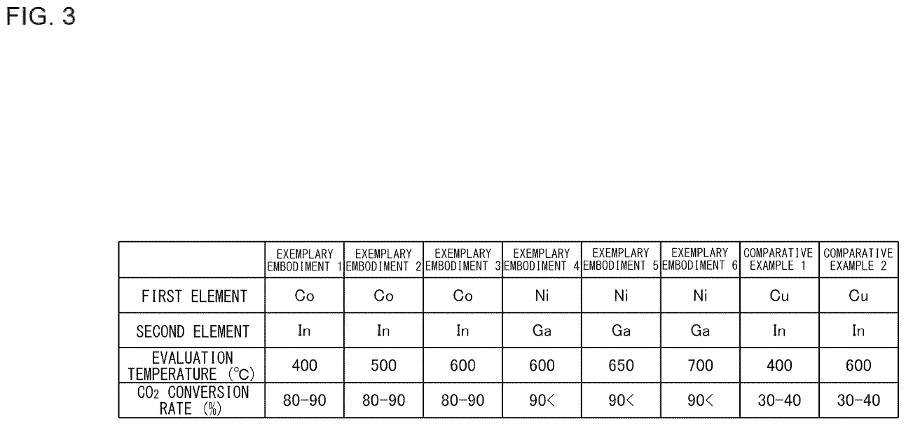

FIG. 3 is a diagram showing the composition, evaluation temperature, and CO₂ conversion rate of a material for a chemical looping system in each exemplary embodiment and each comparative example. The evaluation temperature is the processing temperature in the reduction treatment and the carbon monoxide generation step. Regarding the CO₂ conversion rate, in Exemplary Embodiments 1 to 3, an increase in the weight of the material for the chemical looping system was observed when the CO/CO₂ ratio was 80/20, and a decrease in the weight of the material for the chemical looping system was observed when the CO/CO₂ ratio was 90/10. Therefore, the CO₂ conversion rate was evaluated as 80% to 90%. In Exemplary Embodiments 4 to 6, an increase in the weight of the material for the chemical looping system was observed when the CO/CO₂ ratio was 90/10. Therefore, the CO₂ conversion rate was evaluated as being over 90%. In Exemplary Embodiments 1 and 2, an increase in the weight of the material for the chemical looping system was observed when the CO/CO₂ ratio was 30/70, and a decrease in the weight of the material for the chemical looping system was observed when the CO/CO₂ ratio was 40/60. Therefore, the CO₂ conversion rate was evaluated as 30% to 40%.

As shown in FIG. 3, it has been confirmed that Exemplary Embodiments 1 to 3 where Co—In based materials were used and Exemplary Embodiments 4 to 6 where Ni—Ga based materials were used show a significantly higher CO₂ conversion rate at any evaluation temperature compared to Comparative Examples 1 and 2 where Cu—In based materials were used. Therefore, it has been confirmed that Co—In based materials and Ni—Ga based materials can improve the efficiency of carbon monoxide production in a chemical looping system. Based on this result, it can be inferred that the same effect can be obtained with Co—Ga based materials and Ni—In based materials.

1. A chemical looping system including repeating:
a generation process of reacting a reduced form of a material for the chemical looping system, which contains a first element selected from the group consisting of Co and Ni and a second element selected from the group consisting of In and Ga, with carbon dioxide so as to generate an oxidized form of the material for the chemical looping system, in which the second element is oxidized by the reaction, and carbon monoxide; and
a reduction treatment of reacting the oxidized form with a reducing agent and thus reducing the second element having been oxidized in the generation process so as to thereby convert the oxidized form back into the reduced form.

2. The chemical looping system according to claim 1, wherein
the reduced form of the material for the chemical looping system contains an alloy of the first and second elements.

3. The chemical looping system according to claim 1, wherein
the first element is Co, and the second element is In.

4. The chemical looping system according to claim 1, wherein
the first element is Ni, and the second element is Ga.

5. A material for a chemical looping system, comprising:
a first element selected from the group consisting of Co and Ni and a second element selected from the group consisting of In and Ga.

6. A production method of a material for a chemical looping system, comprising:
heating a precursor that contains a first element selected from the group consisting of Co and Ni and a second element selected from the group consisting of In and Ga at a temperature equal to or greater than reduction treatment temperature for the material for the chemical looping system in the chemical looping system so as to generate the material for the chemical looping system.
